(19) United States
(12) Patent Application Publication
(10) Pub. No.: US 2008/0300330 A1
(43) Pub. Date: Dec. 4, 2008

(54) Foam Extrusion Process Using Multiple Independent Restraining Elements

(76) Inventors: Bruce A. Malone, Midland, MI (US); Martin H. Tusim, Midland, MI (US)

Correspondence Address: The Dow Chemical Company, Intellectual Property Section, P.O. Box 1967, Midland, MI, 48641-1967, US

(21) Appl. No.: 12/091,663

(22) PCT Filed: Oct. 27, 2006
(86) PCT No.: PCT/US06/42001

§ 371 Date: Apr. 25, 2008

Related U.S. Application Data
(60) Provisional application No. 60/738,855, filed on Nov. 22, 2005.

(51) Int. Cl. C08J 9/228

(52) U.S. Cl. 521/80

(57) ABSTRACT

A foam extrusion process using multiple independent restraining elements (50) by extruding a foamable composition from a die to form an expanding polymeric foam and then contact a surface of the foam with multiple independent restraining elements, each having a width less than the width of the expanding foam.

### CROSS REFERENCE STATEMENT

This application claims the benefit of U.S. Provisional Application No. 60/738,855, filed Nov. 22, 2005.

### BACKGROUND OF THE INVENTION

1. Field of the Invention

The present invention relates to a process for preparing extruded polymeric foam, especially thermoplastic polymeric foam.

2. Description of Related Art

Extruded polymeric foam can deform (for example, buckle, warp, or bow) upon extrusion, particularly when the foam has a greater width than thickness. As a result, manufacturing extruded polymeric foam into a specific shape that is substantially wider than it is thick can be challenging.

U.S. Pat. No. 5,206,082 ('082) teaches that closed-cell, non-crosslinked foam structures having an average cell size of from 0.02 to 0.5 millimeters tend to distort, convolute or corrugate when the foam's width is more than 8 times its thickness. '082 proposes that preparing foam planks having an average cell size of from 0.02 to 0.5 mm from coalesced polyethylene foam strands allows manufacture of such foam planks with widths that exceed 8 times the plank thickness without experiencing distortion, convolution, or corrugation. '082 addresses polyethylene foam structures and demonstrates by example the benefit of using coalesced foam strands for a foam having a width up to 16 times the foam thickness.

U.S. Pat. No. 4,395,214 ('214) teaches using an apparatus with planar shaping members directly after an extrusion die in order to form, shape and surface finish a foam extrudate. Foam extrudate expands while traveling between planar shaping members, which restrain the foam's expansion. Planar shaping members are useful when manufacturing polymeric foam structures having planar major surfaces. However, when manufacturing a polymeric foam structure with at least one non-planar major surface the apparatus of '214 is less useful. For example, planar shaping member may not contact enough of a non-planar major surface of a polymeric foam extrudate to dimensionally stabilize the foam structure.

Patent Cooperation Treaty (PCT) publication WO 93/06985 ('985) discloses a method for continuous forming of complex molded shapes, including shaping extruded articles with non-planar surfaces. '985 discloses shaping and dimensionally stabilizing expanding foam extrudate by contacting the extrudate across the extrudate's entire width.

Current extrusion technology leaves much to be desired in the art of manufacturing extruded polymeric foam structures. It is desirable to be able to manufacture an extruded polymeric foam into a dimensionally stable structure whose width exceeds its thickness by 16 fold or more and that comprises polymer compositions other than polyethylene. It is further desirable to be able to prepare such extruded polymeric foam structures with a non-planar primary surface in order to manufacture contoured shapes without having to machine away polymeric foam as waste. It is yet further desirable to be able to extrude such polymeric foam articles having a non-planar surface without having to use an apparatus as complex as that of '985, or even as demanding as to require contacting extrudate across its entire width in order to shape a dimensionally stable polymeric foam article.

### BRIEF SUMMARY OF THE INVENTION

The present invention addresses a need in the art of extruded polymeric foam by providing a process of manufacturing polymeric foams that meets one or more of the aforementioned desirable characteristics.

The present invention is a process for preparing an extruding polymeric foam comprising extruding a foamable composition from a die to form an expanding polymeric foam and then restraining the expanding polymeric foam, wherein the improvement comprises contacting a surface of the expanding polymeric foam with two or more independent restraining elements wherein each independent restraining element has a width less than that of the expanding polymeric foam.

The independent restraining elements provide versatility in positioning of restraining elements relative to one another which allows application of stabilizing restraint to expanding foam that has either a planar or non-planar surface without having to manufacture a restraining die for each foam profile. Furthermore, the independent restraining elements allow manufacture of dimensionally stable foam that has planar or non-planar surfaces without having to contact the foam across its entire width as it expands.

### BRIEF DESCRIPTION OF THE DRAWINGS

FIG. 1 illustrates a general cross-sectional profile of a foam having an non-planar surface.

FIG. 2 illustrates the view of FIG. 1 further including linear rollers acting as restraining elements.

FIG. 3 illustrates the view of FIG. 1 further including multiple rollers acting as independent restraining elements on the non-planar surface of the foam and a single linear roller on a planar surface of the foam.

### DETAILED DESCRIPTION OF THE INVENTION

Extruded foam has a width, thickness and length. Width and thickness correspond to perpendicular dimensions that are mutually perpendicular to a foam's extrusion direction. Foam width is equal to or greater than foam thickness. Typically, width is a horizontal dimension and thickness is a perpendicular dimension relative to foam extrusion. Length corresponds to a dimension that extends along a foam's extrusion direction. When referring to width and thickness of an expanding polymeric foam (which inherently can have a changing width and thickness), the width and thickness corresponds to the foam width and thickness at the point in the extrusion process of interest in the specific context of the reference. For example, the width and thickness at a restraining element corresponds to the width and thickness at of the expanding polymeric foam at the restraining element. Similarly, an average thickness over a specified area (for example, from the die to the restraining element) takes into account any variation in foam thickness inherent in the expanding polymeric foam over that specified area.

An extruded foam (including an extruded expanding polymeric foam and a final foam) has a primary surface. A primary surface has a surface area equal to the highest surface area of any of the foam surfaces. If more than one surface qualifies as a primary surface (that is, two or more have equal surface areas equal to the highest surface area surface of the foam), either of those surfaces can serve as the primary surface of the foam. The primary surface typically extends horizontally when viewing a foam being extruded. A foam's length and width delineate the foam's primary surface.

The extrusion process of the present invention provides an improved method for producing extruded foam and has two general steps: (1) Forming an extruded expanding polymeric foam; and (2) restraining the expanding polymeric foam with discontinuous restraining elements. The following discussion further elaborates on these two steps.

### Step 1: Forming an Extruded Expanding Polymeric Foam

As a general procedure, prepare an extruded expanding polymeric foam by softening a thermoplastic polymer to form a softened polymer, incorporating into the softened polymer a blowing agent composition at an initial pressure to form a foamable polymer composition, and then extruding the foamable polymer composition from an extruder into an environment at a foaming pressure that is lower than the initial pressure. Typically, soften a thermoplastic polymer by heating it to a processing temperature at or above the glass transition temperature (T_{g}) for an amorphous polymer or melt temperature (Tₘ) for a crystalline polymer. When a thermoplastic polymer comprises more than one type of thermoplastic polymer (that is, the polymer is actually a polymer composition), soften the thermoplastic polymer by heating above the T_{g} or Tₘ of each type of thermoplastic polymer comprising the thermoplastic polymer composition. Cooling a foamable polymer composition below the processing temperature while maintaining a softened thermoplastic polymer just prior to extrusion can improve foam properties. Suitable means for cooling a foamable composition include, for example, an extruder or other mixing device or in separate heat exchangers.

Suitable thermoplastic polymers include individual and combinations of polymers selected from a group consisting of polymerized vinyl aromatic monomers such as polystyrene and copolymers containing polymerized vinyl aromatic monomers; alpha-olefin homopolymers such as polyethylene (PE) (including low density polyethylene (LDPE) and high density polyethylene (HDPE)) and polypropylene (PP); linear low density polyethylene (an ethylene/octene-1 copolymer) and other copolymers of ethylene with a copolymerizable, mono-ethylenically unsaturated monomers such as an alpha-olefin having from 3 to 20 carbon atoms; copolymers of propylene with a copolymerizable, mono-ethylenically unsaturated monomer such as an alpha-olefin having from 4 to 20 carbon atoms; copolymers of ethylene with a vinyl aromatic monomer, such as ethylene/styrene interpolymers (ESI); ethylene/propylene copolymers; copolymers of ethylene with an alkane such as an ethylene/hexane copolymer; thermoplastic polyurethanes (TPU's); and blends or mixtures thereof.

Thermoplastic polymers also include coupled thermoplastic polymers such as coupled PP (see, for example U.S. Pat. No. 5,986,009 column 16, line 15 through column 18, line 44; incorporated herein by reference), coupled blends of alpha-olefin/vinyl aromatic monomer or hindered aliphatic vinyl monomer interpolymers with polyolefins (see, for example, U.S. Pat. No. 6,284,842; incorporated herein by reference) and lightly crosslinked polyolefins, particularly PE (see, for example U.S. Pat. No. 5,589,519; incorporated herein by reference). Excessive crosslinking can render a polymer no longer deformable. A skilled artisan can readily determine an acceptable level of crosslinking to obtain a polymer that is still suitably thermoplastic.

A suitable thermoplastic polymer can comprise a blend of at least 50 wt % of a polypropylene and/or polyethylene component in combination with less than 50 wt % of a polymer selected from alkylenyl aromatic polymers such as polystyrene (PS); hydrogenated alkylene aromatic polymers and copolymers such as hydrogenated polystyrene and hydrogenated styrene/butadiene copolymers; rubber-modified alkylene aromatic polymers, such as high impact polystyrene (HIPS); and alkylene aromatic copolymers such as styrene/acrylonitrile or styrene/butadiene. Herein, “and/or” means “in combination with or as an alternative”.

Particularly desirable thermoplastic polymers for use in the present invention include propylene homo- and copolymers. More desirably, the foamable composition contains at least 50 percent by weight (wt %), more desirably at least 70 wt % PP (coupled or uncoupled), by weight of total thermoplastic polymer in the composition. Desirably, the balance comprises a polyethylene component. PP is particularly desirably because it has a higher melt temperature than many other thermoplastic polymers. As a result, PP foams is maintain utility at higher temperatures than foams of other thermoplastic polymers, such as PE. PP is also sufficiently flexible below its melt temperature to form a tough foam that is not particularly brittle (for example, less brittle than PS).

The present process is particularly well suited for use with crystalline and/or semi-crystalline polymer compositions. Crystalline and semi-crystalline polymer compositions become rigid quickly after extruding from a die—expansion is typically complete within centimeters of the die upon extrusion. As a result, restraining elements can establish dimensional stability in foams of crystalline and/or semi-crystalline polymer compositions with restraining contact that lasts moments and extends for less than a centimeter along the foam length. The more crystalline the polymer composition, the more desirable it is for use in the present invention. That is one reason why polypropylene is particularly desirable.

Any blowing agent suitable for forming extruded foam is suitable for use in the process of the present invention. U.S. Pat. No. 5,527,573, for example, describes blowing agents that are suitable for the process of the present invention in column 4, line 66 through column 5, line 20 (incorporated herein by reference). Particularly desirable blowing agents include aliphatic hydrocarbons having a boiling temperature between −50° C. and +50° C. such as n-pentane, iso-pentane, n-butane, iso-butane, propane, and combinations thereof including iso-butane/n-butane blends. Water and carbon dioxide are also desirable blowing agents. Halogenated blowing agents such as 1-chloro-1,1-difluoroethane (HCFC-142) and 1,1,1,2-tetrafluoroethane (HFC-134a) are also suitable blowing agents. A foamable composition can contain any one or a mixture of blowing agents.

A skilled artisan recognizes there are many variations of the general procedure for preparing extruded expanding polymeric foam. For example, U.S. Pat. No. 4,323,528, incorporated herein by reference, discloses a process for extruding expanding polymeric foam with an accumulating extrusion process.

Coalesced polymeric foam processes are also suitable means of preparing an expanding polymeric foam within the scope of the present invention. Coalesced polymeric foams comprise a plurality of distinguishable, coalesced, extruded longitudinal foam members. Longitudinal foam members typically extend the length (extrusion direction) of a coalesced polymeric foam. Longitudinal foam members are strands, sheets, or a combination of strands and sheets. Sheets extend the full width or height of a coalesced polymeric foam while strands extend less than the full width and height. Strands can be of any cross-sectional shape including circular, oval, square, rectangular, hexagonal, or star-shaped. Strands in a single foam can have the same or different cross-sectional shapes. Longitudinal foam members can be solid foam or can be hollow, such as hollow foam tubes (see, for example, U.S. Pat. No. 4,755,408; incorporated herein by reference).

Preparing coalesced polymeric foams typically involves extruding a foamable composition through a die defining multiple holes, such as orifices or slits. The foamable composition flows through the holes, forming multiple streams of expanding polymeric foam. Each stream expands into a foam member. “Skins” form around each foam member. A skin can be a film of polymer resin or polymeric foam having a density higher than an average density of a foam member it is around. Skins extend the full length of each foam member, thereby keeping each foam member within a coalesced polymeric foam distinguishable from neighboring foam members. Foam streams contact one another and their skins join together during expansion, thereby forming a coalesced polymeric foam.

Foamable polymeric compositions (and, therefore, extruded expanding polymeric foam and final foams) of the present invention can contain additives. Suitable additives include inorganic fillers, pigments, anti-oxidants, acid scavengers, ultraviolet radiation absorbers, flame retardants, surfactants, processing aids, extrusion aids, nucleating agents, static dissipating materials, cell enlarging agents, blowing agent permeation modifiers, and thermally insulating additives including aluminum, gold, silver, titanium dioxide, carbon black and graphite. Typically, add additives to a foamable composition prior to exposing the foamable composition to a foaming pressure. A skilled artisan can readily identify suitable combinations and concentrations of additives to achieve desirable properties within a foam.

Step 2: Restraining Extruded Polymeric Foam with Independent Restraining Elements

Restraining an extruded expanding polymeric foam to desirable cross sectional dimensions enhances the expanding foam's dimensional stability and facilitates preparation of a polymeric foam having a specific shape. Conventional processes for restraining extruded expanding polymeric foam use planar restraining elements (for example, flat belts) or linear restraining elements (for example, roller) that extend across the width of the expanding polymeric foam on both a primary surface and a surface opposing the primary surface. The restraining elements restrict the expanding polymeric foam from deforming from a planar shape.

Experience leading to the present invention revealed that conventional planar and linear restraining elements that extend the full width of an expanding polymeric foam tend to be inadequate for stabilizing a non-planar foam, particularly non-planar foam having ridges and valleys such that planar and linear restraining elements only contact the ridges (that is, thicker sections of foam). Experience also indicated that designing and fabricating a restraining element with the precise contour of an expanding polymeric foam can be expensive and lacks versatility for adapting to desired changes in foam contour (for example, design changes that require changing a desired contour of a foam). Therefore, there are problems with conventional processes when it comes to stabilizing non-planar extruded polymeric foams.

Research leading to the present invention revealed that multiple independent restraining elements that together discontinuously contact an expanding foam across the expanding foam's width can both: (1) suitably stabilize the expanding foam whether it has a planar or non-planar surface; and (2) provides versatility by readily being adjustable to different foam profiles without having to purchase or fabricate a new restraining element.

An independent restraining element extends across less than a full width of a foam's surface and is independently positionable or removable relative to another restraining element contacting the same foam surface. For example, two or more independent restraining elements may span a foam's width and each may be adjusted to account for foam thickness or desired position along the foam's width without modifying the position of the other independent restraining elements.

Independent restraining elements can take any form of presently known and future discovered restraining elements provided they extend less than the full width of the foam they restrain and are independently adjustable from another restraining element contacting the same foam surface. For example, an independent restraining element may be a roller or stationary plate (shoe). An independent restraining element may have a tapered (for example, conical roller) or even contoured surface to facilitate intimate contact with a foam's surface. Rollers include elements of any shape (for example, cylindrical, conical, ball-shaped) that rotate on an axis. Rollers can have nearly any composition that is thermally stable when in contact with an expanding foam. Suitable compositions for rollers include metals such as steel, stainless steel, aluminum, brass and bronze; polymers such as fluorocarbon polymers (for example, tetrafluoroethylene) and nylon; and inorganic materials such as ceramics.

Shoes are objects that apply pressure against a foam but, unlike rollers, do not rotate as the foam passes them. Shoes have a face that contacts a foam surface. The shoe face desirably has a contour matching the foam surface that it contacts—a flat surface for a flat portion of foam or a curved face for a curved portion of foam. Shoe faces desirably contact a foam with a material such as polytetrafluoroethylene or other material that creates minimal frictional force as the foam passes the shoe.

Conceivably, a stream or flow of forced gas (for example, air or nitrogen) can serve as an independent restraining element if directed against a surface of an expanding polymeric foam. Such a stream of forced air ideally would be of sufficient dimensions and force to restrain deformation of the expanding polymeric foam while not causing deformation by indenting or cutting into the expanding polymeric foam.

Independent restraining elements have a width that extends in the same dimension as a foam's width the element restrains. The precise width of any single independent restraining element is not critical beyond the fact that it is less than the expanding foam's width. Desirably, an independent restraining element has a width of greater than two millimeters (mm), preferably greater than five mm. Greater widths are desirable because they are less likely to indent into a foam surface. Independent restraining elements typically have a width equal to or less than ½, more typically equal to or less than ⅓, even more typically equal to or less than ¼ of the width of the expanding polymeric foam they restrain. The present method can use one, but desirably uses more than one independent restraining element across an expanding polymeric foam width in order to provide optimal dimensional stability with minimal foam contact and maximum restraining element positional versatility. When a foam surface is non-planar, multiple independent restraining elements provide restraint at critical locations across the foam's width in order to dimensionally stabilize the foam.

Any two discontinuous restraining elements aligned across an expanding foam's width may have the same or different widths and shapes. For example, discontinuous restraining elements can be rollers along a single axis but having different diameters in order to provide restraining contact with an expanding polymeric foam having different thicknesses across the foam's width. One or more restraining element can be a non-cylindrical roller, having, for example, a conical shape in order to contact a foam of tapering thickness across its width.

Independent restraining elements provide positional flexibility and versatility to a foaming process. Such restraining elements allow an artisan to position the restraining elements as necessary to optimally stabilize a foam of any given profile without having to machine specific restraining dies for each new foam profile.

Independent restraining elements can conceivably abut against one another to effectively eliminate spacing between them. However, the independent restraining elements need not provide continuous contact with a foam across the foam's width. One of the benefits of the present invention is an ability to space the restraining elements apart from one another to provide discontinuous contact across a foam's width resulting in less potential drag on the expanding foam. The spacing between independent restraining elements can be a millimeter or more, five millimeters or more, a centimeter or more, even two centimeters or more.

Deformation of expanding foam can occur in the spacing between independent restraining elements. Deformation typically appears as a gap (deformation gap) between a final foam surface and a target profile which the final foam is meant to have (for example, between a flat surface and the surface of a foam that is supposed to be flat). One way to characterize the deformation is by the area of a resulting deformation gap. Measure the deformation gap by placing a foam on a surface having a target profile for that portion of the foam placed against the surface. Measure the area of any gap appearing between the foam and the surface in the spacing between where two restraining elements contacted the foam to determine the deformation gap forming between those restraining elements.

The area of a deformation gap is a function of the spacing between two restraining elements (D) and the average foam thickness between the two restraining elements (Tₐᵥₑ). The present invention involved discovering this dependency and characterizing it with Eqn 1:

DeformationGap=111.5 mm²−(9.7 mm)(Tₐᵥₑ)+(15.5 mm)(D) Eqn 1

wherein the Deformation Gap is in square millimeters (mm²), Tₐᵥₑ is in millimeters (mm) and D is in millimeters.

Rearranging Eqn 1 to solve for D provides Eqn 2:

$$D = \frac{DeformationGap + ( 19.7 mm ) ( {T}_{ave} ) - 111.5 {mm}^{2}}{15.5 mm} \qquad Eqn 2$$

Optimal dimensional stability produces an absence of a deformation gap (gap area of zero mm²), which corresponds to a restraining element spacing equal to or less than 1.27(Tₐᵥₑ)−70.2 mm.

Generally, a deformation gap of 30 mm² or less (a D value equal to or less than 1.27(Tₐᵥₑ)−5.3 mm) is acceptable because it still allows a foam to be readily conformable to the foam's target profile. The deformation gap is desirably 100 mm² or less (a D value equal to or less than 1.27(Tₐᵥₑ)−0.74 mm) or it becomes difficult to conform a foam to the foam's target profile.

Measure D as a linear distance between two adjacent restraining elements projected onto the width dimension of an expanding foam. In other words, D is the distance of the element-element spacing in millimeters along the expanding foam's width dimension. For example, the element-element spacing between two restraining elements in a line along an expanding polymeric foam's width corresponds to the space between the restraining elements. The element-element spacing between two restraining elements that are not in a line along an expanding foam's width corresponds to the space between the elements projected onto a line along the expanding foam's width.

Conventional planar and linear restraining elements can suffer from a problem of being unable to contact an expanding polymeric foam within an element-element spacing small enough to prevent excessive foam deformation when peaks in a foam profile are further apart than the desirable D values identified above for desirable deformation gap spacings. Contoured restraining elements that contact an expanding polymeric foam across the foam's full width contact the foam more than is necessary and are not easily adjusted to accommodate foam profile changes.

As a solution to problems with conventional restraining elements, the present invention provides multiple (that is, two or more) discontinuous restraining elements that provide restraining contact with an expanding polymeric foam yet none of the restraining elements extend the full width of the polymeric foam. Unlike conventional restraining elements, independent restraining elements allow an artisan to intentionally contact or not contact a foam surface at whatever spacing the artisan desires. Independently restraining elements further allow an artisan to readily modify one restraining element apart from the others, thereby granting flexibility to accommodate any size, shape and contour of expanding polymeric foam. Independent restraining elements further allow a skilled artisan to dimensionally stabilize an expanding polymeric foam by positioning the restraining elements at an optimal element-element spacing.

The present process is useful for extruding polymeric foams that have planar surfaces, but is particular useful for extruding polymeric foams that have at least one non-planar surface. The independent restraining elements of the present invention are desirably independently positionable to accommodate uneven foam profiles unlike planar and linear restraining elements. As a result, a skilled artisan can position the independent restraining elements so to restrain a foam at critical element-element spacings so to maintain a desired foam shape (that is, avoid foam deformation) and establish dimensional stability.

Generally, a process has opposing restraining elements on opposing surfaces of a foam. In the present process, the restraining elements on at least one of the opposing surfaces comprise (or, preferably, consist of) independent restraining elements. Therefore, processes of the present invention can have independent restraining elements contacting one or both opposing surfaces of an expanding polymeric foam. Typically, one of those surfaces is the primary surface of the expanding polymeric foam.

An extruded expanding polymeric foam can also suffer from dimensional deformation in the form of ripples or rolls along the extrusion direction of the foam if restraining elements fail to contact the expanding polymeric foam within a critical die-element spacing from the extrusion die. To determine this critical die-element spacing follow the same guidelines as determining element-element spacing from Eqn 1 and Eqn 2 but where D becomes the die-element spacing instead of element-element spacing. Therefore, dimensional stability occurs when the die-element spacing is equal to or less than 1.27(T′ₐᵥₑ)−0.74 mm. Better dimensional stability occurs when the die-element spacing is equal to or less than 1.27(T′ₐᵥₑ)−5.3 mm. Optimal dimensional stability occurs when the die-element spacing is equal to or less than 1.27(T′ₐᵥₑ)−7.2 mm. T′ₐᵥₑ is an average thickness of the foam between the extruder die and the restraining element.

Restraining elements have optimal effect on inhibiting foam deformation if they continue to contact and restrain the foam until the foam ceases to expand (that is, grow), though can contact the expanding foam for less time. Therefore, the optimal length for restraining elements is a function of the polymer formulation and extrusion flow rate. A skilled artisan can readily determine optimal restraining element lengths for a polymer formulation and extrusion rate of interest as well as the extent of tolerable deformation they can afford to have.

The process of the present invention produces a final extruded polymeric foam (final foam) once the expanding polymeric foam ceases to expand (grow). The final foam can be cut to desirable lengths and further processed as desired.

The process of the present invention allows manufacture of final foam that has an absence of observable deformation (for example, buckling, warping or bowing) from a desired shape. The final foam can have a width that exceeds its average thickness, or even its greatest thickness, by 16 fold or more. Observable deformation means visually apparent deformation to an unaided eye.

Moreover, the present invention provides for the manufacture of stabilized polymeric foams that vary in thickness across a cross section such that the ratio to thickest to thinnest portion of the foam is 2 or more, even 3 or more, still more even 3.5 or more and can prepare such a stabilized foam without having to contact the full width of a corresponding expanding polymeric foam during manufacture.

The polymeric foam can be either open-celled or close-celled polymeric foams. Close-celled foams have less than 20% open-celled content according to ASTM method D-6226. Open-cell foams have 20% or more, preferably 50% or more, more preferably 70% or more open-cell content according to ASTM method D-6226. Open-celled foams tend to be more flexible than close-celled foams. However, close-celled foams are advantageously better thermal insulators than open-celled foams.

The polymeric foam is limited to any particular cell size, but usually has a cell size of 0.1 millimeters (mm) or more, preferably 0.2 mm or more and usually 1.0 mm or less, preferably 0.5 mm or less.

The polymeric foam is not limited to any particular density, but usually has a density of 0.5 pounds-per-cubic-foot (pcf) (8 kilograms per cubic meter (kg/m³)) or more, preferably 0.8 pcf (13 kg/m³) or more and usually five pcf (80 kg/m3) or less, preferably three pcf (48 kg/m³) or less, more preferably 1.5 pcf (24 kg/m³) or less.

The following examples serve to illustrate embodiments of the present invention and not limit or define the scope of the present invention.

### Planar Board Examples

Prepare a foamable composition by combining additives and blowing agent with a softened polymer composition in an extruder. The softened polymer composition comprises a blend of 65 percent by weight (wt %) high viscosity general purpose polypropylene (for example, PP-6823 available from Basell Polyolefins), 15 wt % general purpose branched polypropylene (for example, PF-814 available from Basell Polyolefins), and 20 wt % low density polyethylene (for example, PL-1880 available from The Dow Chemical Company) wherein wt % is relative to polymer blend weight. Soften the polymer composition in an extruder at approximately 220 degrees Celsius (° C.). Add to the softened polymer composition 6.7 parts per hundred (pph) of an Irganox□-type stabilizer (Irganox is a tradename of Ciba Specialty Chemicals), 0.2 pph talc concentrate (15 wt % active talc compounded in PF-814) and 0.6 pph 4654 MC-blue concentrate (available from Ampacet). Determine pph by weight of total polymer blend. Incorporate into the softened polymer composition at a pressure of 3200 pounds per square inch (psi) (22 MegaPascals) 1-chloro, 1,1-difluoroethane (HCFC-142b) blowing agent at a concentration of 24 pph for foams having a density of one (1) pound per cubic foot (pcf) (16 kilograms per cubic meter (kg/m³)) and 16 pph for foams having a density of 1.8 pcf (28.8 kg/m³).

Cool the foamable polymer composition to 160° C. and extrude through a strand foam die at a pressure of 650 psi (4.5 MegaPascals) to atmospheric pressure to form an expanding polymeric foam. The strandfoam die has a series of holes in a hexagonal (closest packed) pattern such that the space between holes is 0.126 inches (3.2 millimeters (mm)) and the diameter of the holes is 0.033 inches (0.84 mm). Use a hole pattern that is 60 holes wide to create a foam that is approximately ten inches (254 mm) wide. Prepare foams at each density and at two different thicknesses—use a pattern four holes high for the thicker foam and three holes high for the thinner foam.

Position side rollers after the die with their rotational axis vertical to the direction of extrusion to deter horizontal expansion of the expanding polymeric foam. Use of such rollers increases the likelihood of foam buckling and mimics resistance typically inherent in larger scale foam extrusion.

Contact the expanding polymeric foam underneath with a single roller that extends the full width of the expanding polymeric foam and above with a series of two-inch (51 mm) diameter and one-inch (25 mm) wide nylon rollers. Position all of the rollers as close as possible to the die without actually contacting the die and with the axis of rotation for each roller normal to the extrusion direction of the foam (that is, a die-element spacing of approximately 26 mm). Position one nylon roller on either side of the extruded foam with the edge of the roller aligned with the outermost hole in the die. Position the remaining rollers at the roller to roller spacing (roller spacing) distances shown in Tables 1 and 2.

After extruding foams at different densities, thicknesses and roller spacings place each foam on a flat surface and apply mild pressure to hold them stationary. Measure the area of any gap under the foam. Ideal foams will be flat with a gap area of zero square millimeters (mm²) since flat, panel foams were the target shape. Any gaps represent deformation.

Tables 1 and 2 tabulate foam parameters for planar samples of various thicknesses, roller spacings and resulting gap under resulting foam for samples at the two different density levels described above. Table 1 presents data from foams having a density of one pcf (16 kg/m³) and Table 2 presents data from foams having a density of 1.8 pcf (28.8 kg/m³).

TABLE 1
Foam density = 1 pcf (16 kg/m³)

| | |
|---|---|
| Roller Spacing | Deformation Gap Area |
| (mm) | under Foam (mm²) |

| D | 16 mm Thick Foam | 22 mm Thick Foam |
|---|---|---|
| 13 | 0 | 0 |
| 19 | 20 | 0 |
| 25 | 150 | 30 |
| 32 | 270 | 60 |

TABLE 2
Foam density = 1.8 pcf (28.8 kg/m³)

| | |
|---|---|
| Roller Spacing | Deformation Gap Area |
| (mm) | under Foam (mm²) |

| D | 13 mm Thick Foam | 19 mm Thick Foam |
|---|---|---|
| 13 | 0 | 0 |
| 19 | 80 | 0 |
| 25 | 365 | 30 |

These foam samples illustrate that deformation is a function of roller spacing and foam thickness and that negligible deformation, even an absence of deformation is possible without using a continuous shaping force across an expanding foam. These samples also illustrate that foam deformation is negligibly dependent upon foam density.

### Non-Planar Foam

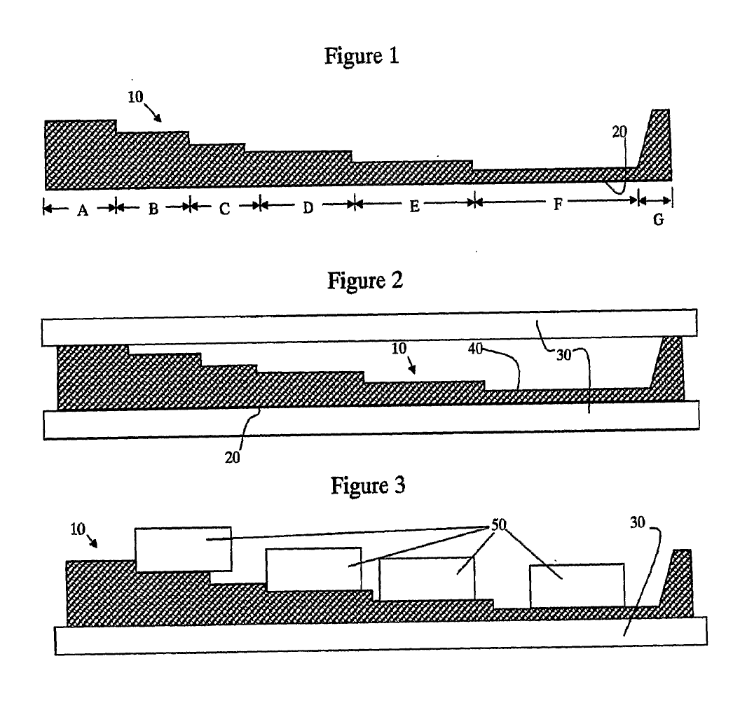

Prepare non-planar foams in a manner similar to the planar samples except using a die having a hole configuration corresponding to a 21 cm wide foam, with a cross section as illustrated in FIG. 1 generally at 10. The target foam shape has seven sections corresponding to widths A-G. The sections differ in thickness, yet the overall foam has a flat bottom 20. Section of width A is three cm thick and two cm wide. Section of width B is 2.6 cm thick and two cm wide. Section of width C is 2.2 cm thick and 2.4 cm wide. Section of width D is 1.8 cm thick and three cm wide. Section of width E is 1.2 cm thick and 4.2 cm wide. Section of width F is 0.8 cm thick and 5.7 cm wide. Section of width G taper from a thickness of 0.8 cm to three cm over a width of 1.7 cm.

Modify the foamable composition from that of the planar samples by using a softened polymer composition of 52 wt % high viscosity general purpose linear polypropylene (for example, PP-6823), 19.5 wt % general purpose branched polypropylene (for example, PF-814) and 20 wt % low density polyethylene (for example, PL-1880) and incorporating 22 pph HCFC-142b blowing agent. Wt % and pph are based on softened polymer composition weight. Extrude at a rate of 150 pounds (68 kg) per hour.

### Comparative Non-Planar Example

Extrude a non-planar foam using a single roller contacting the planar bottom surface and the surfaces of sections A and G on the top surface of the foam. (See, for example, FIG. 2 where cross section of the foam is shown generally at 10 and the single rollers 30 contact a portion of the top surface 40 and bottom surface 20 of the foam 10). Position the rollers as close to the extrusion die as possible without contacting the die.

The resulting foam deforms by buckling under sections of width E and F to generate a 360 mm² gap.

### Non-Planar Example

Extrude a non-planar foam using a single roller contacting the planar bottom surface and independent rollers 50 (1.25 inches (3.2 cm) wide and 2 inches (5.1 cm) in diameter) contacting the non-planar surface with one roller centrally located in each of sections of width D, E and F and one spanning section of width B. There is no more than 9.5 mm spacing between any two rollers. (Positioning of the rollers 50 is shown general relative to foam 10 in FIG. 3). Position the rollers as close to the extrusion die as possible without contacting the die.

The resulting foam reveals negligible gaps when its bottom (planar) surface is set on a flat surface, indicating negligible deformation during extrusion and expansion.

This example illustrates that multiple independent restraining elements providing discontinuous contact across a foam's width can produce a dimensionally stable foam. This example also illustrates the value of using independent restraining elements to create a dimensionally stable foam having a non-planar surface.

1. A process for preparing an extruding polymeric foam comprising extruding a foamable composition from a die to form an expanding polymeric foam and then restraining the expanding polymeric foam, wherein the improvement comprises contacting a surface of the expanding polymeric foam with two or more independent restraining elements wherein each independent restraining element has a width less than that of the expanding polymeric foam.

2. The process of claim 1, wherein the independent restraining elements are selected from a group consisting of rollers, shoes and a stream of forced gas.

3. The process of claim 1, wherein at least one of the independent restraining elements is a roller.

4. The process of claim 1, wherein at least one of the independent restraining elements is a shoe.

5. The process of claim 1, wherein the independent restraining elements are at least 2 millimeters wide.

6. The process of claim 1, wherein the independent restraining elements are less than ½ of the width of the expanding polymeric foam.

7. The process of claim 1, wherein independent restraining elements contact a primary surface of the expanding polymeric foam and additional independent restraining elements contact a surface opposing the primary surface of the expanding polymeric foam.

8. The process of claim 1, wherein the independent restraining elements contact a planar foam surface.

9. The process of claim 1, wherein the independent restraining elements contact a non-planar foam surface.

10. The process of claim 1, wherein two of the restraining elements have a spacing between them and the spacing is a centimeter or more.

11. The process of claim 1, wherein each independent restraining element contacts the expanding polymeric foam at a distance equal to or less than 1.27(T′ₐᵥₑ)−0.74 millimeters of the die, wherein T′ₐᵥₑ is an average thickness of the expanding polymeric foam over a spacing between the die and the independent restraining element in millimeters.

12. The process of claim 1, wherein each pair of independent restraining elements have an element-element spacing distance between them equal to or less than 1.27(Tₐᵥₑ)−0.74 millimeters wherein Tₐᵥₑ is an average thickness in millimeters of the expanding polymeric foam over the element-element spacing distance.

13. The process of claim 1, wherein the expanding polymeric foam comprises polypropylene homopolymer, copolymer, or a combination of homopolymer and copolymer.

14. The process of claim 1, wherein the expanding polymeric foam comprises at least 50 percent propylene polymer by weight of the expanding polymer foam.

15. The process of claim 1, wherein the expanding polymeric foam comprises at least 50 percent polyethylene by weight of the expanding polymer foam.

16. The process of claim 1, wherein the expanding polymeric foam comprises at least 50 percent of a polymer selected form polystyrene and polystyrene copolymers by weight of the expanding polymeric foam.

17. The process of claim 1, wherein the expanding polymeric foam comprises multiple expanding polymeric foam streams that form a coalesced strand foam.

18. The process of claim 1, wherein one or more of the independent restraining elements are rollers that each have a width less than ¼ of the expanding polymeric foam width at the restraining element and any given independent restraining element is within an element-element spacing distance of any neighboring independent restraining element equal to or less than 1.27(Tₐᵥₑ)−0.74 millimeters wherein Tₐᵥₑ is an average thickness of the foam in the element-element spacing and a die-element spacing distance from the die equal to or less than 1.27(T′ₐᵥₑ)−0.74 millimeters wherein T′ₐᵥₑ is an average thickness of the foam in the spacing between the die and the given restraining element and wherein the resulting polymeric foam has a width that is more than 16 times as large as the polymeric foam's average thickness.
